(19) United States
(12) Patent Application Publication
(10) Pub. No.: US 2023/0080458 A1
(43) Pub. Date: Mar. 16, 2023

(54) Per-Subscriber Virtual Segmentation of an Active Ethernet Network on Multi-Tenant Properties

(71) Applicant: RG Nets, Inc., Reno, NV (US)

(72) Inventors: Simon C. Lok, Reno, NV (US); Darrian Hale, Reno, NV (US); Lannar Dean, Reno, NV (US)

(73) Assignee: RG Nets, Inc., Reno, NV (US)

(21) Appl. No.: 17/477,281

(22) Filed: Sep. 16, 2021

(51) Int. Cl. H04L 12/28; H04L 12/46; H04L 9/14

(52) U.S. Cl. CPC H04L 12/2859; H04L 12/4679; H04L 12/2881; H04L 12/2874; H04L 9/14

(57) ABSTRACT

The present systems and methods enable Internet service providers and managed service providers to deploy a segmented network for multiple subscribers on a shared active Ethernet distribution medium, where each subscriber can be associated with one or more unique public IP addresses, and each subscriber also has control of their own gateway configuration. The system leverages the per-subscriber dynamic 802.1q VLAN approach enforced through compatible wireless and wireline distribution equipment in combination with optional multiple PSK zero-touch LAN onboarding and public IP WAN address assignment mechanisms, along with an onboard multi-tenant subscriber portal. The result is a network architecture that incorporates per-subscriber segmentation and security features, while simultaneously providing centralized radio resource management, property-wide roaming, instantaneous onboarding, and the like.

### TECHNICAL FIELD

The subject of this patent application relates generally to virtualizing business and/or residential gateways to deliver segmented subscriber Internet access.

### BACKGROUND

By way of background, commercial and/or residential multi-tenant properties provide Internet access to the tenants through use of Internet service providers (ISP) or managed service operators (MSO) networks. Privacy concerns require that each of these tenants (each having an opportunity to be a subscriber to the service) be isolated from one another and treated as independent entities. In standard local area networks (LAN), each network node is permitted to communicate with all other network nodes (e.g., to share files, print to network printers, cast to network connected displays, and so on), which would be undesirable in a multi-tenant property network, where privacy is paramount. Thus, ISP and MSO networks are usually architected with network technology that is specific to broadband access delivery that includes subscriber physical segmentation, where a unique physical segment is deployed for each subscriber.

The unique physical segments deployed for each subscriber connects to a distribution network that is tied to an upstream Internet border, such as a cable modem termination system (CMTS) or a passive optical network optical line terminal (PON OLT) at the head end of a network that serves hundreds or thousands of unique subscribers. In this case, each subscriber is connected to the network through independent customer premises equipment (CPE), such as a cable modem (CM) or an optical network terminal (ONT), provided to each and every subscriber.

In another example, there are network devices capable of implementing network segmentation at the logical link layer. These networks are designed to allow a single physical network to deliver connectivity to multiple independent logical organizational units. This capability is defined by IEEE standards 802.1q for virtual local area networks (VLAN) and 802.1aq for I-SIDs, generally implemented by standard enterprise networking equipment. Segmenting ISP and MSO networks generally requires per-subscriber segmentation that is much larger in scale than enterprise LANs. The IEEE 802.1ad standard was created to extend virtualized data-link network segmentation so that it can be used for large scale ISP and MSO networks. Thus, an ISP or MSO network may deploy logical segmentation capable active Ethernet switches to create a network that can be configured with data-link layer virtual service network controlled by the provider with additional data-link layer segmentation that is controlled by the subscriber. However, there is a lack of logical subscriber organization in the existing shared active Ethernet network architecture.

In multi-tenant properties (e.g., traditional office buildings, co-working spaces, residential multi-dwelling unit complexes, and the like), ISP and MSO and networks establish physical segmentation by deploying an individual customer premise equipment on the property for each subscriber. Physical segmentation, however, has its drawbacks, such as onboarding and provisioning delays, inability to roam across the property, customer premise equipment losses due to misuse, vandalism, theft, etc. A per-tenant segmentation assignment architecture is desirable in this scenario, but requires an informed segment assignment strategy that increases complexity and creates difficulties in its implementation.

The segmentation of a large network that is inherently designed to enable every device to communicate with one another into a large quantity of smaller logical isolated network segments exposes the operator to a significant number of challenges. Assignment of devices to segments is accomplished in enterprise networks through network access control (NAC) software. Existing enterprise NAC systems are designed to assign a large number of devices to a small number of segments. Enterprise NAC systems assume that a corporate directory server can be used to direct assignments based on group membership or that a network administrator is available to manually assign MAC addresses. These approaches are inadequate for ISP and MSO micro-segmentation deployments that involve a large number of organizational units composed entirely of end-user devices for which the MAC addresses are not known ahead of time.

Furthermore, segment assignment (also known as dynamic VLAN assignment) only addresses locally bridged communications, and does permit devices to access the Internet. Proper assignment of devices to segments enables LAN communication but does not directly influence WAN connectivity. Each organizational unit associated with a virtual network in a micro-segmented network architecture may have unique WAN connectivity requirements. The application of enterprise networking equipment is insufficient to meet the requirements presented in public access or ISP networks due to the large number of organizational units. Enterprise network equipment is designed to serve a small number of organizational units and be managed by a skilled technical professional. Even relatively small-scale micro-segmented network designs with only, for example, one hundred segments are either unsupported or unmanageable with enterprise networking Internet gateways.

Configuration of unique routing policies for different segments that service independent organizational units is a difficult problem to solve. The management of enterprise networks that support only a single organizational unit (OU) or a small quantity of OUs consumes vast quantities of human labor to manage simple services, such as packet filtering, port forwarding, assignment of public IP addresses, and so on. Thus, using standard enterprise networking equipment to deploy ISP and/or MSO networks in multi-tenant environments is undesirable.

Therefore, there is a need for an improved system that enables a service provider to deploy micro-segmented active Ethernet networks using the per-unit VLAN approach on a shared property, with zero operator intervention provisioning.

### SUMMARY

Aspects of the present systems and methods teach certain benefits in construction and use which give rise to the exemplary advantages described below.

The present systems and methods provides virtual micro-segmentation of an active ethernet network shared by a plurality of subscribers each occupying a unit of a multi-tenant property, and generally comprises one or more processors; memory; and at least one computer-readable storage medium having stored therein instructions which, when executed by the one or more processors, cause the one or more processors to perform operations comprising: configure, by an operator front end, a subscriber account associated with subscriber authentication credentials, which includes assignment of a pre-shared key associated with and unique to the subscriber account; implement, by a subscriber front end, a subscriber front-end interface, wherein subscriber authentication credentials associated with a subscriber account are collected; create, by an orchestrator backend, a virtual gateway associated with the subscriber account upon authentication of subscriber authentication credentials, wherein network infrastructure changes unique to the subscriber account are permitted to be made through the subscriber front end; store, in a shared database, subscriber data associating the virtual gateway, the subscriber account, and the pre-shared key; and onboard, by an orchestrator backend, a subscriber first device associated with the subscriber account using the pre-shared key unique to the subscriber account.

In one or more optional embodiments, the present systems and methods further provides a subscriber second device associated with the subscriber account is onboarded using the pre-shared key unique to the subscriber account.

In one or more optional embodiments, the present systems and methods further provides a second subscriber account that is configured with assignment of a second pre-shared key associated with and unique to the second subscriber account.

In one or more optional embodiments, the present systems and methods further provides that the operator front end, the subscriber front end, and the orchestrator backend are integrated within a software defined network gateway comprising an orchestrator, a remote authentication dial-in user service server, and a virtual local area network database. And, optionally, the software defined network gateway organizes local area network traffic into a plurality of organizational units with each subscriber account being associated with a unique organizational unit assigned a unique network segment that enables the software defined network gateway to present a unique virtual residential gateway to each subscriber account. And, optionally, the software defined network gateway is configured to operate in conjunction with wireline virtual local area network switch and a wireless local area switch controller.

Other features and advantages of aspects of the present systems and methods will become apparent from the following more detailed description, taken in conjunction with the accompanying drawings, which illustrate, by way of example, the principles of aspects of the invention.

### BRIEF DESCRIPTION OF DRAWINGS

FIG. 1 schematically depicts a high-level diagram of hardware that may be used to implement various aspects of the present system in certain embodiments;

FIG. 2. is a high-level system diagram of the relevant parts of an exemplary embodiment of the present system; and

FIG. 3. is a system diagram of the relevant parts of an exemplary embodiment of the present system.

The above-described drawing figures illustrate aspects of the present system in at least one of its exemplary embodiments, which are further defined in detail in the following description.

### DETAILED DESCRIPTION

The detailed description set forth below in connection with the appended drawings is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. It is to be understood, however, that the same or equivalent functions and sequences may be accomplished by different embodiments that are also intended to be encompassed within the spirit and scope of the invention.

Systems, apparatus, and methods described herein may be implemented using digital circuitry, or using one or more computers using well known computer processors, memory units, storage devices, computer software, and other components. Typically, a computer includes a processor for executing instructions and one or more memories for storing instructions and data. A computer may also include, or be coupled to, one or more storage devices, such as one or more magnetic disks, internal hard disks and removable disks, optical disks, etc.

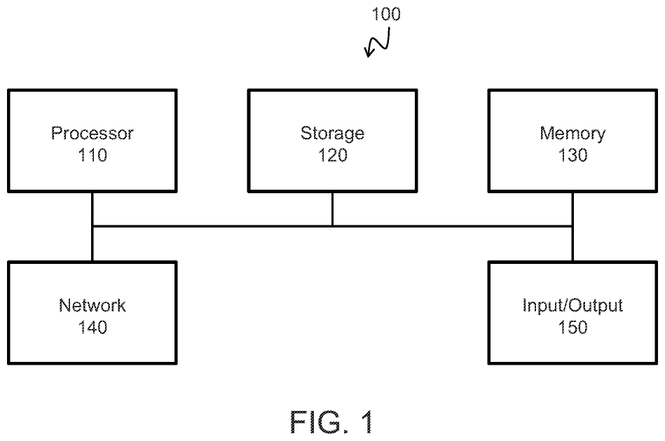

A high-level block diagram of an exemplary computer 100 that may be used to implement systems, apparatus, and methods described herein is illustrated in FIG. 1. For example, the present systems and methods may be implemented by such an exemplary computer. The computer 100 comprises a processor 110 operatively coupled to a data storage device and memory. Processor 110 controls the overall operation of computer 100 by executing computer program instructions that define such operations. The computer program instructions may be stored in data storage device 120, or other non-transitory computer readable medium, and loaded into memory 130 when execution of the computer program instructions is desired. Thus, the modules described for the present system can be defined by the computer program instructions stored in memory 130 and/or data storage device 120 and controlled by processor 110 executing the computer program instructions.

Computer 100 includes one or more network interfaces 140 for communicating with other devices via a network. Computer 100 may also include one or more input/output devices 150 that enable user interaction with computer 100 (e.g., display, keyboard, touchpad, mouse, speakers, buttons, etc.).

Processor 110 can include, among others, special purpose processors with software instructions incorporated in the processor design and general purpose processors with instructions in storage device 120 or memory 130, to control the processor 110, and may be the sole processor or one of multiple processors of computer 100. Processor 110 may be a self-contained computing system, containing multiple cores or processors, a bus, memory controller, cache, etc. A multi-core processor may be symmetric or asymmetric. Processor 110, data storage device 120, and/or memory 130 may include, be supplemented by, or incorporated in, one or more application-specific integrated circuits (ASICs) and/or one or more field programmable gate arrays (FPGAs). It can be appreciated that the disclosure may operate on a computer 100 with one or more processors 110 or on a group or cluster of computers networked together to provide greater processing capability.

Data storage device 120 and memory 130 each comprise a tangible non-transitory computer readable storage medium. By way of example, and not limitation, such non-transitory computer-readable storage medium can include random access memory (RAM), high-speed random access memory (DRAM), static random access memory (SRAM), double data rate synchronous dynamic random access memory (DDRRAM), read-only memory (ROM), erasable programmable read-only memory (EPROM), electrically erasable programmable read-only memory (EEPROM), flash memory, compact disc read-only memory (CD-ROM), digital versatile disc read-only memory (DVD-ROM) disks, or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Network/communication interface 140 enables the computer 100 to communicate with networks, such as the Internet, also referred to as the World Wide Web (WWW), an intranet and/or a wireless network, such as a cellular telephone network, a wireless local area network (LAN) and/or a metropolitan area network (MAN), and other devices using any suitable communications standards, protocols, and technologies. By way of example, and not limitation, such suitable communications standards, protocols, and technologies can include Ethernet, Wi-Fi (e.g., IEEE 802.11), Wi-MAX (e.g., IEEE 802.16), VLAN (e.g., IEEE 802.1Q), Bluetooth, near field communications (“NFC”), radio frequency systems, infrared, GSM, EDGE, HS-DPA, CDMA, TDMA, quadband, VoIP, IMAP, POP, XMPP, SIMPLE, IMPS, SMS, or any other suitable communications protocols. By way of example, and not limitation, the network interface 140 enables the computer 100 to transfer data, synchronize information, update software, or any other suitable operation.

Input/output devices 150 may include peripherals, such as a printer, scanner, monitor, etc. Input/output devices 150 may also include parts of a computing device. In some embodiments, the computer 100 acts as a headless server computer without input/output devices 150. Input/output devices 150 (further including but not limited to keyboards, displays, pointing devices, etc.) can be coupled to the system either directly or through intervening I/O controllers.

Any or all of the systems and apparatus discussed herein, including personal computers, tablet computers, hand-held devices, cellular telephones, servers, database, cloud-computing environments, virtual compute environment and components thereof, may be implemented using a computer such as computer 100. An implementation of an actual computer or computer system may have other structures and may contain other components as well.

The present systems and methods enable Internet service providers and managed service providers to deploy a segmented network for multiple subscribers on a shared active Ethernet distribution medium where each subscriber can be associated with one or more unique public IP addresses, and each subscriber also has control of their own gateway configuration. The system leverages the per-subscriber dynamic 802.1q VLAN approach enforced through compatible wireless and wireline distribution equipment in combination with optional multiple PSK zero-touch LAN onboarding and public IP WAN address assignment mechanisms, along with an onboard multi-tenant subscriber portal. The result is a network architecture that incorporates per-subscriber segmentation with security features (e.g., subscriber segmentation, inbound data control and nonrepudiation), while simultaneously providing centralized radio resource management, property-wide roaming, instantaneous onboarding, and the like.

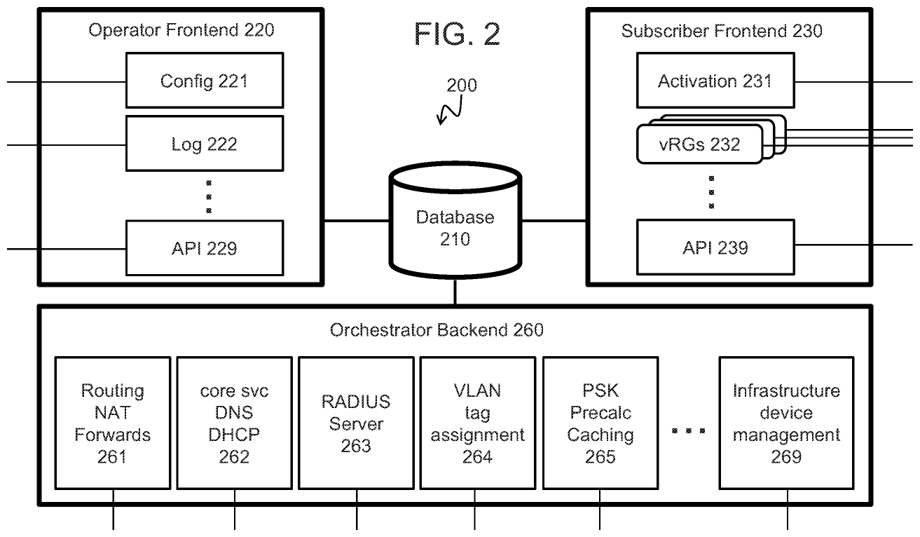

FIG. 2 illustrates a high-level representation of some of the components of such a computer. In one or more embodiments, the system 200 comprises an operator frontend 220, a subscriber frontend 230, and an orchestrator backend 260. The operator frontend 220, the subscriber frontend 230, and the orchestrator backend 260 all share a unified database 210.

The operator frontend 220 provides a complete GUI and CLI for management of the system including but not limited to configuration 221, log recovery 222, and application programming interface (API) 229. The operator frontend 220 stores all data received from operator interaction in the shared database 210. The operator frontend 220 allows the network operator to manually configure the network as a whole via CLI/GUI or programmatically via API configure as well as recover subscriber activity logs. In one or more example embodiments, the operator front end 220 receives input from the network operator for configuring a new subscriber account, where a subscriber account name and passphrase can be assigned and associated with a subscriber and/or the subscriber's unit, and stored in the shared database 210.

The subscriber frontend 230 is a comprehensive multi-tenant aware end-user GUI with support for all end-user interaction including but not limited to account activation with customer relationship management and operations support system (CRM/OSS) billing integration 231, per-subscriber (e.g., per-tenant, where the subscriber is also a tenant) virtualized residential gateway services (vRG) 232, and an application programming interface (API) 239. The subscriber front-end 230 stores all data received from subscriber interaction in the shared database 210. The subscriber front-end allows the subscriber to control their own individual virtual residential gateway, as well as access the customer-facing aspects of the ISP/MSO customer relationship management operational support system (CRM/OSS).

The orchestrator backend 260 is a comprehensive management system that receives data stored in the shared database 210 and interprets the data to configure network services, including but not limited to routing services 261, network services 262, RADIUS 263, VLAN tag assignment 264, PSK precalculation 265, and infrastructure device management 269. The orchestrator backend 260 coordinates the configuration of all of the networking components required to implement the virtualized residential gateway network architecture.

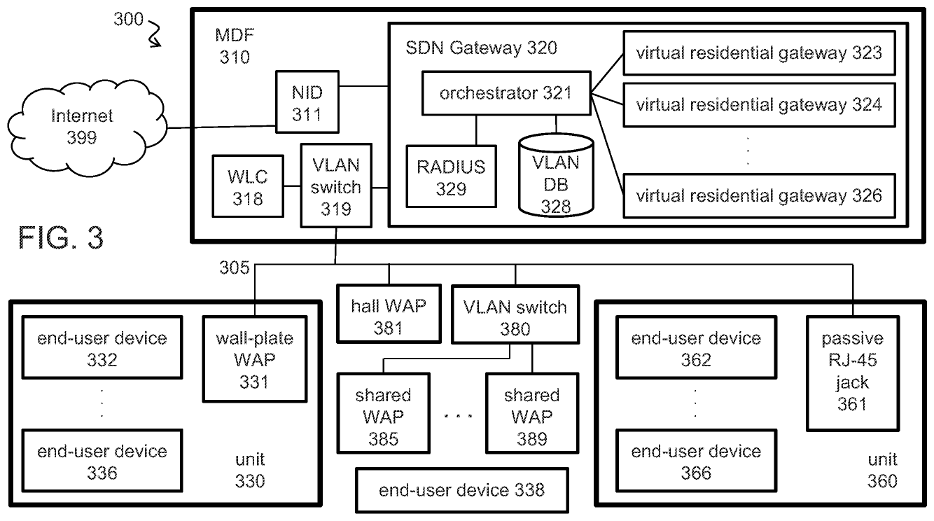

Turning now to FIG. 3, an active Ethernet distribution network 300 is illustrated that utilizes an exemplary implementation of the present systems and methods as a software defined networking (SDN) gateway 320 to allow an ISP and/or an MSO to deliver segmented Internet access to subscribers on the premises, which can be a multi-tenant buildings or group of buildings.

A network interface device (NID) 311, that connects the provider network to the wiring inside the premises provides and physical connectivity to the Internet 399, is typically installed by the uplink provider in the main data frame (MDF) 310, usually located within the building. The exemplary software defined network (SDN) gateway 320 is the head end of the network that provides dynamic host configuration protocol (DHCP), domain name system (DNS), network address translation (NAT), and, optionally, other core networking services that would normally be expected of a service gateway.

In one or more embodiments, the SDN gateway 320 comprises an orchestrator 321, a remote authentication dial-in user service (RADIUS) server 329, and a VLAN database 328. The SDN gateway 320 delivers a micro-segmented network architecture with subscriber self-provisioning through automatic dynamic virtual local area network (DVLAN) assignment with one or both of the wireless LAN controller 318 and the wireline VLAN switches 319, 380, where wireline VLAN switch 319 is a core network switch and wireline VLAN switch 380 is an intermediate data frame switch.

In one or more embodiments, the SDN gateway 320 further incorporates a multi-tenant virtual residential gateway mechanism that is capable of creating a multiplicity of virtual residential gateways 323, 324, . . . 326, which can be created and destroyed automatically by the SDN gateway 320. Subscribers are only permitted to interact with the virtual residential gateway that is assigned to their microsegment. This interaction permits managing inbound connectivity, pre-shared keys (PSKs), instant activation, and other networking functions that would be provided by standard customer premises equipment if present. The SDN gateway may also be integrated with external on-premises and/or off-premises cloud services including but not limited to operational support services, billing services, customer relationship management services, networking monitoring services, element management services, and the like, if desired. However, the present SDN gateway 320 is designed to be comprehensive, turn-key, and capable of operating in a stand-alone environment.

A VLAN capable core network switch 319 and Ethernet structured cabling 305 provides power-over-Ethernet (PoE) segmented network trunks throughout the property. In one or more embodiments, active network infrastructure (e.g., a wall plate wireless access point 331 and/or a passive network jack 362) can be installed within the units 330, 360, respectively. Switch ports that are connected to wall plate access points 331 will typically be configured to trunk all VLANs, while switch ports connected to passive RJ-45 wall jacks 361 will typically be configured to be native VLAN access ports.

In one or more embodiments, the present system provides network infrastructure such as intermediate data frame VLAN switches 380 and wireless access points 381, 385 . . . 389 for hallways and other common areas. End-user devices 332 . . . 336 and 362 . . . 366 (each device among a potential plurality owned by each individual subscriber) may be connected to the network inside the tenant units 330, 360, respectively, or in common areas 338, depending on the availability of wireless network signal and wireline jacks. In one or more embodiments, there can be more than one subscriber in a unit, such as when roommates share an apartment or two businesses a collated in a shared office space. In one or more embodiments, there can be more than one user per subscriber account.

The present network architecture provides instantaneous delivery of service for new subscribers and new subscriber devices through subscriber self-provisioning, with strong segmentation between subscribers. Subscribers arrive on the property with their own devices and connect to the present network, without the need for obtaining customer premises equipment. In one or more embodiments, the tenant is assigned a subscriber account with a default passphrase that can be changed upon the first login. The SDN gateway 320 organizes the local area network traffic into a large number of organizational units (OUs), where each organizational unit is associated a particular segment that contains all the subscriber devices that belong to that particular subscriber. Each subscriber is separated into a unique organizational unit, where each organizational unit is assigned a unique network segment, that enables the SDN gateway 320 to present a unique virtual residential gateway (vRG) 323, 324 . . . 326 to each subscriber, where the present system is capable of separating many hundreds or more subscribers and providing each a distinct vRG.

In an exemplary use of the illustrated system 300, a first subscriber (associated with a first subscriber account) residing in (and associated with) a first unit 330 is assigned a first virtual residential gateway 323. And, a second subscriber (associated with a second subscriber account) residing in (and associated with) a second unit 360 is assigned a second virtual residential gateway 326. The first subscriber can have a plurality of first devices that can be associated with the first subscriber account. Likewise, the second subscriber can have a plurality of second devices that can be associated with the second subscriber account.

Using the first subscriber as an example representing capabilities available all like subscribers, the first subscriber can interact with the first virtual residential gateway 323 (and only interact with the first virtual residential gateway 323 associated with the first subscriber account) at any time using a web browser or an optional mobile device application that interacts with the virtual residential gateway 323 through an application programming interface (API). In this way, the first subscriber is able to make network infrastructure changes that are unique to their segment (the first segment) without requiring the use of customer premises equipment (such as an ISP provided modem/router), which is possible even though the overall physical architecture is a shared active Ethernet, where this type and level of subscriber control was heretofore not possible.

The exemplary embodiment of the present virtual residential gateway enables the subscriber to configure everything that would be configurable in a physical residential gateway, as well as unique features that are only available due to the present underlying shared infrastructure. Capabilities of the exemplary implementation of the present virtual residential gateway include, for example, configuration of port forwarding, universal plug-and-play, dynamic DNS and wireless PSK, configuration of temporary shifting of device segments for device collaboration and/or gaming, temporary bonding of two operational units, specification of roaming behavior, and so on.

In one or more embodiments, an SDN orchestration software module coordinates the various networking components, including, but not limited to, VLAN assignments, DHCP scope calculation, default gateway IP address definitions, NAT and forwarding rule generation, and the like. The exemplary implementation of the present systems and methods includes an integrated version of each of the major components required for Internet gateway operation, including a RADIUS server, DHCP server, NAT router, firewall, content filter, DPI engine, and the like. The present systems and methods can also include orchestration of external networking infrastructure components using any remote command mechanism including telnet, SSH, RESTCONF, NETCONF, other APIs, and the like.

In one or more embodiments, the SDN orchestration software module contains logic that enables intelligent selection and manipulation of subscriber wireless pre-shared keys (PSKs). In one or more embodiments, WLAN infrastructure equipment enables the operator to specify a unique PSK for each subscriber device (of a potential plurality of subscriber devices) connecting to the same SSID (e.g., the first subscriber can have device 1, device 2, device 3 . . . device n). The WLAN infrastructure equipment can optionally be chosen to support external PSK specification. The SDN orchestrator 321 communicates with WLAN infrastructure to assign PSKs to clients over any remote AAA mechanism, such as RADIUS, RESTCONF, NETCONF, other APIs, and the like.

In one or more embodiments, the present SDN orchestration module utilizes a WLAN controller with a multiple externalized PSK mechanism to enforce a residential gateway specific policy for PSK management of the subscriber network. The virtualized residential gateway subscriber portal includes a mechanism to configure the passphrase for each user for their particular account, and no other account. The same PSK is shared between all the devices of an individual subscriber; and likewise, each and every other subscriber has a unique PSK. This enables the operator to deploy a single unified physical layer SSID with a unique logical layer segment and unique over-the-air encryption passphrase for each and every subscriber.

In one or more embodiments, zero-touch onboarding of unknown devices is implemented via a novel workflow in the PSK manager component of the SDN orchestrator 321 that is specific to the virtualized residential gateway architecture. This PSK manager component must infer the subscriber to which the unknown device belongs on the present single, property-wide network for the wireless component.

The WPA2 4-way handshake specifically inhibits the transfer of the PSK entered in the PSK directly to the network infrastructure. Thus, the SDN orchestrator 321 guesses likely PSKs to provide to the infrastructure. PSK guessing, in a heuristic manner, is enhanced with information gathered from the infrastructure, such as the basic service set identifiers BSSID (i.e., MAC address) of the access point, the RADIUS Called-Station-ID, the geospatial location of neighboring access points, subscriber recent activity logs, and so on. Optional partial precalculation of possible PSKs enables rapid PSK match finalization to maximize performance. Implementations with precalculation enabled have been successful in guessing the correct PSK at the largest wireless networks in existence. In one or more embodiments, the present systems and methods is able to correctly determine the appropriate subscriber on the first try with less than 1 failure per 100 new devices when deployed in realistic scenarios when precalculation is disabled. The failure rate drops to less than 1 per 10,000 new devices when a second try is allowed when precalculation is disabled.

The present systems and methods include a multi-tenant end-user portal (the subscriber frontend) that provides a subscriber self-management GUI. The multi-tenant end-user portal enables subscribers to set parameters relevant to their individual gateway functionality through the GUI, such as inbound port forwards, outbound port translation, dynamic DNS, and Wi-Fi PSK. The multi-tenant end-user portal also integrates all of the usual subscriber provisioning functionality found in an ISP operational support system, such as usage plan selection, recurring billing profile, public IP allocation, and so on. The multi-tenant end-user portal also includes a manual onboarding feature for use when the zero-touch onboarding is either not available or fails to correctly enroll a new device. All features are enabled for zero operator intervention provisioning and intended for deployment in a subscriber self-managed manner.

The multi-tenant implementation of the end-user portal integrated within the present systems and methods, ensures that each subscriber can only edit configuration parameters and provision subscriptions for their own account. The SDN orchestration module of the invention is also multi-tenant aware. The multi-tenant awareness of the subscriber front-end GUI and back-end orchestrator enable centralized virtualization of residential gateway functionality. Each orchestrated component (e.g., routing, NAT, DHCP, PSK management, and the like) is automatically configured with per-subscriber micro-segmentation. The combination of the multi-tenant aware portal with the multi-tenant aware SDN orchestrator enables a single instance of the present systems and methods to virtualize hundreds or thousands of residential gateways onto a single platform. In one or more embodiments, the present systems and methods can create more than 50 virtual residential gateways, or more than 100 virtual residential gateways, or more than 200 virtual residential gateways, or more than 300 virtual residential gateways, or more than 400 virtual residential gateways, or more than 500 virtual residential gateways, or more than 1,000 virtual residential gateways, or more than 2,000 virtual residential gateways.

In one example use of the present systems and methods, port forwards support peer-to-peer real-time services, such as voice chat for multiplayer gaming, virtual public network services, peer-to-peer file sharing, remote management of LAN resources, and the like. Each subscriber that wishes to have an inbound port forward, is assigned one or more unique or shared public IPs. The IP address assignment is often influenced by the usage plan chosen by the subscriber, because the operator may wish to enforce a (recurring) fee for the exclusive or shared use of one or more public IPs. The present systems and methods automate the purchase, inventory management, and provisioning of all aspects of the subscription, such as public IPs, bandwidth limit, quota, device count, and the like, to facilitate zero operator intervention provisioning.

The SDN orchestrator module is aware of the complete provisioning profile for each subscriber and configures the various network modules appropriately. The subscriber may manually define which port forwards that they would like or the subscriber may enable the multi-tenant aware UPnP server. The SDN orchestrator collects the information and configures the packet processing engine with the appropriate rules, such as be utilizing an integrated open-source packet filtering and forwarding engine. However, a different implementation may integrate with an external router or firewall to achieve the same functionality.

The present systems and methods also include an interface and API (i.e., the operator frontend) that allows the operator to configure all of the described features. The operator may choose to have a network engineering log into an individual instance and make changes on an individual basis or use the API to execute a mass change to multiple instances in parallel. This allows the operator to maintain complete control over the subscriber experience over all networks that are managed by the present systems and methods.

The unique combination of subscriber self-management portals, operator-controlled GUI and API, and automation and orchestration implemented by the present systems and methods, enables large scale rapid deployment of reliable and secure subscriber networks that leverage cost-efficient networking architectures while maintaining a low support volume and thus maximize ISP/MSO profitability.

Further, looking broadly at the system, it can take the form of an entirely hardware embodiment, an entirely software embodiment or an embodiment containing both hardware and software elements. In one embodiment, the system is implemented in software, which includes but is not limited to firmware, resident software, microcode, etc.

Furthermore, the system can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium comprise a semiconductor or solid-state memory, magnetic tape, a removable computer diskette, a random-access memory (RAM), a read-only memory (ROM), a rigid magnetic disk and an optical disk. Current examples of optical disks comprise compact disk-read only memory (CD-ROM), compact disk-read/write (CD-R/W) and DVD.

A data processing system suitable for storing and/or executing program code comprises at least one processor coupled directly or indirectly to memory elements through a system bus. The memory elements can include local memory employed during actual execution of the program code, bulk storage, and cache memories that provide temporary storage of at least some program code in order to reduce the number of times code is retrieved from bulk storage during execution.

Described above, aspects of the present application may be embodied in a World Wide Web (“WWW”) or (“Web”) site accessible via the Internet. As is well known to those skilled in the art, the term “Internet” refers to the collection of networks and routers that use the Transmission Control Protocol/Internet Protocol (“TCP/IP”) to communicate with one another. The internet 20 can include a plurality of local area networks (“LANs”) and a wide area network (“WAN”) that are interconnected by routers. The routers are special purpose computers used to interface one LAN or WAN to another. Communication links within the LANs may be wireless, twisted wire pair, coaxial cable, or optical fiber, while communication links between networks may utilize 56 Kbps analog telephone lines, 1 Mbps digital T-1 lines, 45 Mbps T-3 lines or other communications links known to those skilled in the art.

A remote access user may retrieve hypertext documents from the World Wide Web via a web browser program. A web browser, such as GOOGLE's CHROME, MOZILLA's FIREFOX, or MICROSOFT's EDGE, is a software application program for providing a user interface to the WWW. Upon request from the remote access user via the web browser, the web browser requests the desired hypertext document from the appropriate web server using the URL for the document and the hypertext transport protocol (“HTTP”). HTTP is a higher-level protocol than TCP/IP and is designed specifically for the requirements of the WWW. HTTP runs on top of TCP/IP to transfer hypertext documents and user-supplied form data between server and client computers. The WWW browser may also retrieve programs from the web server, such as JAVA applets, for execution on the client computer. Finally, the WWW browser may include optional software components, called plug-ins, that run specialized functionality within the browser.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims appended hereto.

1. A system comprising:
a. one or more processors;
b. memory; and
c. at least one computer-readable storage medium having stored therein instructions which, when executed by the one or more processors, cause the one or more processors to perform operations comprising:
i. configure, by an operator front end, a subscriber account associated with subscriber authentication credentials, which includes assignment of a pre-shared key associated with and unique to the subscriber account, where the subscriber account is assigned a separate, unique segment configured to operate on an active ethernet network shared by a plurality of subscribers each occupying a unit of a multi-tenant property;
ii. implement, by a subscriber front end, a subscriber front-end interface, wherein subscriber authentication credentials associated with a subscriber account are collected;
iii. create, by an orchestrator backend, a separate virtual gateway associated with and unique to the subscriber account upon authentication of subscriber authentication credentials, said virtual gateway being assigned a unique public IP address, wherein configuration changes unique to the subscriber account are permitted to be selectively applied by the virtual gateway that are specific to one or more segments of the subscriber account through the subscriber front end;
iv. store, in a shared database, subscriber data associating the virtual gateway, the subscriber account, and the pre-shared key; and
v. onboard, by an orchestrator backend, a subscriber first device associated with the subscriber account using the pre-shared key unique to the subscriber account.

2. The system of claim 1 wherein, a subscriber second device associated with the subscriber account is onboarded using the pre-shared key unique to the subscriber account.

3. The system of claim 1 wherein, a second subscriber account is configured with assignment of a second pre-shared key associated with and unique to the second subscriber account, where the second subscriber account is assigned a second unique segment.

4. The system of claim 1 wherein the operator front end, the subscriber front end, and the orchestrator backend are integrated within a software defined network gateway comprising an orchestrator, a remote authentication dial-in user service server, and a virtual local area network database.

5. The system of claim 4 wherein the software defined network gateway organizes local area network traffic into a plurality of organizational units with each subscriber account being associated with a unique organizational unit assigned a unique network segment that enables the software defined network gateway to present a unique virtual residential gateway to each subscriber account.

6. The system of claim 5 wherein the software defined network gateway is configured to operate in conjunction with wireline virtual local area network switch and a wireless local area switch controller.

7. A method comprising the steps of:
a. configuring, by an operator front end, a subscriber account associated with subscriber authentication credentials, which includes assigning of a pre-shared key associated with and unique to the subscriber account, where the subscriber account is assigned a separate, unique segment configured to operate on an active ethernet network shared by a plurality of subscribers each occupying a unit of a multi-tenant property, the first subscriber associated with a first unit of the multi-unit property;
b. configuring, by the operator front end, a second subscriber account associated with subscriber authentication credentials, which includes assigning of a second pre-shared key associated with and unique to the second subscriber account, where the second subscriber account is assigned a second unique segment, the second subscriber associated with a second unit of the multi-unit property;
c. implementing, by a subscriber front end, a subscriber front-end interface, wherein subscriber authentication credentials associated with a subscriber account are collected;
d. implementing, by a second subscriber front end, a second subscriber front-end interface, wherein subscriber authentication credentials associated with a second subscriber account are collected;
e. creating, by an orchestrator backend, a separate virtual gateway associated with and unique to the subscriber account and a second, separate virtual gateway associated with and unique to the second subscriber account upon authentication of each subscriber authentication credentials, said virtual gateways each being assigned a unique public IP address, wherein configuration changes unique to the subscriber account are permitted to be selectively applied by the virtual gateway that is specific to one or more segments of the subscriber account through the subscriber front end and the second subscriber front end and configuration changes unique to the second subscriber account are permitted to be selectively applied by the second virtual gateway that is specific to one or more segments of the second subscriber account through the second subscriber front end;
d. storing, in a shared database, subscriber data associating the virtual gateway, the subscriber account, and the pre-shared key and subscriber data associating the virtual gateway, the subscriber account, and the pre-shared key; and
e. onboarding, by an orchestrator backend, a subscriber first device associated with the subscriber account using the pre-shared key unique to the subscriber account and a second subscriber first device associated with the second subscriber account using the second pre-shared key unique to the second subscriber account.

8. The method of claim 7 wherein, a subscriber second device associated with the subscriber account is onboarded using the pre-shared key unique to the subscriber account and a second subscriber second device associated with the second subscriber account is onboarded using the second pre-shared key unique to the second subscriber account.

9. (canceled)

10. The method of claim 7 wherein the operator front end, the subscriber front end, the second subscriber front end, and the orchestrator backend are integrated within a software defined network gateway comprising an orchestrator, a remote authentication dial-in user service server, and a virtual local area network database.

11. The method of claim 10 wherein the software defined network gateway organizes local area network traffic into a plurality of organizational units with each of a plurality of subscriber accounts being associated with a unique organizational unit assigned a unique network segment that enables the software defined network gateway to present a unique virtual residential gateway to each of the plurality of subscriber accounts.

12. The method of claim 11 wherein the software defined network gateway is configured to operate in conjunction with wireline virtual local area network switch and a wireless local area switch controller.

13. A non-transitory computer-readable storage medium having stored therein instructions which, when executed by a processor, cause the processor to perform operations comprising:
a. providing an active ethernet network shared by a plurality of subscriber accounts each associated with occupation of a unit of a multi-tenant property, where each of the plurality of subscriber accounts is assigned a separate, unique segment configured to operate on an active ethernet network shared by a plurality of subscriber accounts;
b. configuring, by an operator front end, a subscriber account associated with subscriber authentication credentials, which includes assigning of a pre-shared key associated with and unique to the subscriber account;
c. implementing, by a subscriber front end, a subscriber front-end interface, wherein subscriber authentication credentials associated with a subscriber account are collected;
d. creating, by an orchestrator backend, a separate virtual gateway associated with and unique to the subscriber account upon authentication of subscriber authentication credentials, said virtual gateway being assigned a unique public IP address, wherein configuration changes unique to the subscriber account are permitted to be selectively applied by the virtual gateway that are specific to one or more segments of the subscriber account through the subscriber front end;
e. storing, in a shared database, subscriber data associating the virtual gateway, the subscriber account, and the pre-shared key; and
f. onboarding, by an orchestrator backend, a subscriber first device associated with the subscriber account using the pre-shared key unique to the subscriber account.

14. The non-transitory computer-readable storage medium of claim 13 wherein, a subscriber second device associated with the subscriber account is onboarded using the pre-shared key unique to the subscriber account.

15. The non-transitory computer-readable storage medium of claim 13 wherein, a second subscriber account is configured with assignment of a second pre-shared key associated with and unique to the second subscriber account.

16. The non-transitory computer-readable storage medium of claim 13 wherein the operator front end, the subscriber front end, and the orchestrator backend are integrated within a software defined network gateway comprising an orchestrator, a remote authentication dial-in user service server, and a virtual local area network database.

17. The non-transitory computer-readable storage medium of claim 13 wherein the software defined network gateway organizes local area network traffic into a plurality of organizational units with each of the plurality of subscriber accounts being associated with a unique organizational unit assigned a unique network segment that enables the software defined network gateway to present a unique virtual residential gateway to each of the plurality of subscriber accounts.

18. The non-transitory computer-readable storage medium of claim 13 wherein the software defined network gateway is configured to operate in conjunction with wireline virtual local area network switch and a wireless local area switch controller.
